(19) United States
(12) Patent Application Publication
(10) Pub. No.: US 2015/0269902 A1
(43) Pub. Date: Sep. 24, 2015

(54) LIQUID CRYSTAL DISPLAY

(71) Applicant: Samsung Display Co., Ltd., Yongin-City (KR)

(72) Inventor: Chil Son HONG, Seongnam-si (KR)

(21) Appl. No.: 14/661,692

(22) Filed: Mar. 18, 2015

(30) Foreign Application Priority Data
Mar. 21, 2014 (KR) 10-2014-0033645

(51) Int. Cl. G09G 3/36

(52) U.S. Cl. CPC G09G 3/3696; G09G 2300/0408; G09G 2300/0426; G09G 2320/0242

(57) ABSTRACT

A liquid crystal display includes: a first substrate, on which a first pixel, a second pixel and a third pixel are defined, where the first pixel, the second pixel and the third pixel display different colors from each other; a first electrode disposed on the first substrate; a second electrode disposed on the first substrate; an insulating layer disposed between the first electrode and the second electrode; a second substrate disposed opposite to the first substrate; and a liquid crystal layer injected between the first substrate and the second substrate, where a first thickness of the insulating layer in the first pixel is different from a second thickness of the insulating layer in the second pixel.

This application claims priority to Korean Patent Application No. 10-2014-0033645 filed on Mar. 21, 2014, and all the benefits accruing therefrom under 35 U.S.C. §119, the contents of which in its entirety is herein incorporated by reference.

### BACKGROUND

1. (a) Field

Exemplary embodiments of the invention relate to a liquid crystal display.

2. (b) Description of the Related Art

A liquid crystal display (“LCD”) is one of the most widely used types of flat panel display, and LCD typically displays images by applying voltages to field-generating electrodes to generate an electric field in an liquid crystal (“LC”) layer that determines orientations of LC molecules therein to adjust polarization of incident light.

The LCD may have light weight and thin thickness, while the LCD may has lateral visibility that is lower than front visibility thereof. Accordingly, LC arrangements and driving methods of various types have been developed to improve the lateral visibility. To realize a wide viewing angle, an LCD including a pixel electrode and a reference electrode that are provided on one substrate has been developed.

In such an LCD, at least one of two field generating electrodes of the pixel electrode and the common electrode has a plurality of cutouts, and a plurality of branch electrodes defined by the plurality of cutouts.

The LCD uses a backlight to display the image, and an opening ratio of red, green and blue pixels may be controlled or the driving voltage of the red, green and blue pixels may be differentiated to control color coordinates of the backlight.

### SUMMARY

In a liquid crystal display, where the opening ratio of each pixel are controlled (e.g., differently set) or the driving voltage of each pixels are differently set, the aperture ratio of the liquid crystal display or the driving voltage may be decreased such that the entire transmittance of the liquid crystal display may be decreased.

Exemplary embodiments of the invention relate to a liquid crystal display in which color coordinates of the liquid crystal display are controlled during a process of providing the pixel electrode and the common electrode on one substrate to effectively prevent a reduction of transmittance of the liquid crystal display.

In an exemplary embodiment, a liquid crystal display includes: a first substrate, on which a first pixel, a second pixel and a third pixel are defined, where the first pixel, the second pixel and the third pixel display different colors from each other; a first electrode disposed on the first substrate; a second electrode disposed on the first substrate; an insulating layer disposed between the first electrode and the second electrode; a second substrate disposed opposite to the first substrate; and a liquid crystal layer disposed between the first substrate and the second substrate, where a first thickness of the insulating layer in the first pixel is different from a second thickness of the insulating layer in the second pixel.

In an exemplary embodiment, the second thickness of the insulating layer in the second pixel may be different from a third thickness of the insulating layer in the third pixel.

In an exemplary embodiment, a first cell interval in the first pixel may be different from a second cell interval in the second pixel.

In an exemplary embodiment, the second cell interval in the second pixel may be different from a third cell interval in the third pixel.

In an exemplary embodiment, a plurality of cutouts may be defined in one of the first electrode and the second electrode, and the one of the first electrode and the second electrode may include a plurality of branch electrodes defined by the plurality of cutouts.

In an exemplary embodiment, a difference between the first thickness of the insulating layer and the second thickness of the insulating layer may be larger than about zero (0) micrometer (μm) to less than about 0.5 μm, and a difference between the second thickness of the insulating layer and the third thickness of the insulating layer may be larger than about zero (0) μm to less than about 0.5 μm.

In an exemplary embodiment, the difference between the first cell interval in the first pixel and the second cell interval in the second pixel may be larger than about zero (0) μm to less than about 0.5 μm, and the difference between the second cell interval in the second pixel and the third cell interval in the third pixel may be larger than about zero (0) μm to less than about 0.5 μm.

An exemplary embodiment of a liquid crystal display including a first pixel, a second pixel, and a third pixel displaying different colors from each other includes: a first substrate; a first electrode disposed on the first substrate; a second electrode disposed on the first substrate; an insulating layer disposed between the first electrode and the second electrode; a second substrate disposed opposite to the first substrate; and a liquid crystal layer disposed between the first substrate and the second substrate, where the first cell interval in the first pixel is different from the second cell interval in the second pixel.

According to exemplary embodiments of a liquid crystal display of the invention, where the pixel electrode and the common electrode are disposed on a same substrate, the color coordinates of the liquid crystal display may be controlled by differently setting the cell intervals of the pixels that displays different colors from each other without a transmittance reduction of the liquid crystal display.

### BRIEF DESCRIPTION OF THE DRAWINGS

The above and other features of the invention will become more apparent by describing in further detail exemplary embodiments thereof with reference to the accompanying drawings, in which:

FIG. 1 is a schematic cross-sectional view of an exemplary embodiment of a liquid crystal display according to the invention;

FIG. 2 is a plan view of an exemplary embodiment of a liquid crystal display according to the invention;

FIG. 3 is a cross-sectional view taken along line III-Ill of the liquid crystal display of FIG. 2;

FIG. 4 is a plan view of an alternative exemplary embodiment of a liquid crystal display according to the invention; and

FIG. 5 is a cross-sectional view taken along line V-V of the liquid crystal display of FIG. 4.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of a liquid crystal display according to the invention will be described with reference to accompanying drawings.

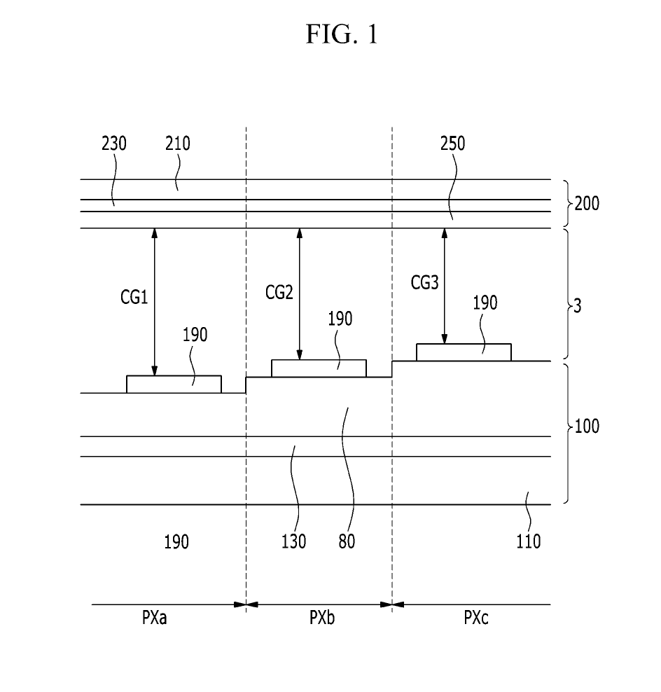

Now, an exemplary embodiment of a liquid crystal display according to the invention will be described with reference to FIG. 1. FIG. 1 is a schematic cross-sectional view of an exemplary embodiment of a liquid crystal display according to the invention.

Referring to FIG. 1, an exemplary embodiment of the liquid crystal display according to the invention includes a first display panel 100, a second display panel 200 disposed opposite to the first display panel 100, and a liquid crystal layer 3 disposed between the first and second display panels 100 and 200. In such an embodiment, the liquid crystal display includes a first pixel PXa, a second pixel PXb and a third pixel PXc, which display different colors from each other. To allow the liquid crystal display to display color images, each pixel PXa, PXb, and PXc may uniquely display one of primary colors, the primary colors are spatially or temporally synthesized, and thus a desired color is recognized. In such an embodiment, the primary colors may include three primary colors of red, green, and blue, for example, but not being limited thereto.

The first display panel 100 includes a first electrode 130 and a second electrode 190, which are disposed on a first substrate 110 and overlapping each other via an insulating layer 80 disposed therebetween.

The insulating layer 80 may include an organic material.

In such an embodiment, a first thickness D1 of the insulating layer 80 in the first pixel PXa is different from a second thickness D2 of the insulating layer 80 in the second pixel PXb. A difference of the first thickness D1 and the second thickness D2 may be larger than about zero (0) micrometer (μm) and less than about 0.5 μm.

In such an embodiment, the second thickness D2 of the insulating layer 80 in the second pixel PXb is different from a third thickness D3 of the insulating layer 80 in the third pixel PXc. A difference of the second thickness D2 and the third thickness D3 may be larger than about zero (0) μm and less than about 0.5 μm.

In an exemplary embodiment, the thickness of the insulating layer 80 may be controlled during a manufacturing process thereof by using a half tone exposure mask for exposure of the insulating layer 80. In one exemplary embodiment, for example, by disposing a photomask including a translucent area as well as a light transmitting area and a light blocking area, the insulating layer 80 having different heights depending on a position may be formed. The translucent area includes a slit pattern, a lattice pattern, or a thin film having a middle transmittance or a middle thickness. Herein, the middle transmittance or the middle thickness may be determined with reference to the transmittance or thickness of a thin film corresponding to the light transmitting area and a light blocking area. In an exemplary embodiment, where the translucent area includes the slit pattern, the width of the slit or the interval between the slits may be less than a resolution of a light exposer used in a photo-process.

In an exemplary embodiment, as shown in FIG. 1, the second display panel 200 includes a color filter 230 and an overcoat 250, which are disposed on a second substrate 210. In an alternative exemplary embodiment, the color filter 230 may be disposed on the first display panel 100, and in such an embodiment, the insulating layer 80 of the first display panel 100 may be the color filter.

In an exemplary embodiment, a cell interval, which is an interval between the first display panel 100 and the second display panel 200, may be different in the first pixel PXa, the second pixel PXb and the third pixel PXc. In such an embodiment, the first cell interval CG1 of the first pixel PXa is different from the second cell interval CG2 of the second pixel PXb, and the second cell interval CG2 of the second pixel PXb is different from the third cell interval CG3 of the third pixel PXc.

In an exemplary embodiment, the difference between the first cell interval CG1 of the first pixel PXa and the second cell interval CG2 of the second pixel PXb may be larger than about zero (0) μm to less than about 0.5 μm. In such an embodiment, the difference between the second cell interval CG2 of the second pixel PXb and the third cell interval CG3 of the third pixel PXc may be larger than about zero (0) μm to less than about 0.5 μm.

As described above, the cell interval may be differentiated in the first pixel PXa, the second pixel PXb and the third pixel PXc due to the different thicknesses of the insulating layer 80 in the first pixel PXa, the second pixel PXb and the third pixel PXc. In such an embodiment, color coordinate values may be controlled by controlling the cell intervals of the pixels that display the different colors.

Hereinafter, the control of the color coordinate values by controlling the cell intervals of the pixels will be described in greater detail.

In a liquid crystal display, a value of the transmittance of the liquid crystal display may be determined by Equation 1.

$$T = {sin}^{2} ( 2 φ ) \cdot {sin}^{2} ( \frac{Γ}{2} ) \\ Γ = \frac{2 π Δ nd}{λ} , φ = effective aimuthal angle \qquad ( Equation 1 )$$

In the pixel displaying red, for example, if the cell interval (d) is increased, in Equation 1, a value of Δnd is increased. Accordingly, the transmittance of light having a large wavelength (λ) is increased. Accordingly, the long wavelength transmittance is increased.

In the liquid crystal display, the color coordinates Wx and Wy of the light are determined by a ratio of a tristimulus value as expressed in Equation 2 and Equation 3.

Wx=X/(X+Y+Z) (Equation 2)

Wy=Y/(X+Y+Z) (Equation 3)

Here, the tristimulus value is determined based on a color matching function. The tristimulus value means an amount of red, green and blue included in the color displayed by a light source or an object color, and is denoted by X, Y and Z. Accordingly, when the measured value X is relatively greater, more red is expressed in the displayed color, when the measured value Y is relatively greater, more green is expressed in the displayed color, and when the measured value Z is relatively greater, more blue is expressed in the displayed color.

When the long wavelength transmittance is increased, the value X is increased among the tristimulus values of the color such that the value Wx is increased. If the cell interval of the pixel for displaying the red is increased by about 0.1 μm, for example, the value Wx in the color coordinates is increased by about 2/1000.

Similarly, in the pixel for displaying the blue, if the cell interval (d) is decreased, the value Δnd is decreased in Equation 1. Accordingly, the transmittance of the light having the small wavelength (λ), that is, the short wavelength, is increased. Accordingly, the short wavelength transmittance is increased.

When the short wavelength transmittance is increased, the values X and Z among the tristimulus values of the color are increased, and thereby the value Wy is decreased. If the cell interval of the pixel for displaying the blue is decreased by about 0.1 μm, for example, the value Wy among the color coordinates is decreased by about 3/1000.

As described above, by controlling the cell intervals CG of the first pixel PXa, the second pixel PXb and the third pixel PXc, the values of the color coordinates Wx and Wy may be controlled.

In such an embodiment, the cell interval of each pixel may be controlled by controlling the thickness of the insulating layer 80, such that the entire transmittance of the liquid crystal display may be effectively prevented from being decreased, which may occur due to controlling the opening ratio of each pixel and the driving voltage.

According to an exemplary embodiment of the liquid crystal display of the invention, by forming the first electrode 130 and the second electrode 190 on a same substrate, e.g., on the first substrate 110, and controlling the thickness of the insulating layer disposed between the first electrode and the second electrode to control the cell intervals of the pixels that display the different colors, the values of the color coordinates may be controlled. Therefore, according to an exemplary embodiment of the liquid crystal display of the invention, the pixel electrode and the common electrode may be provided on a same substrate without any reduction of the transmittance of the liquid crystal display, such that the color coordinates of the liquid crystal display may be effectively controlled.

Next, a detailed structure of an exemplary embodiment of the liquid crystal display according to the invention will be described with reference to accompanying drawings.

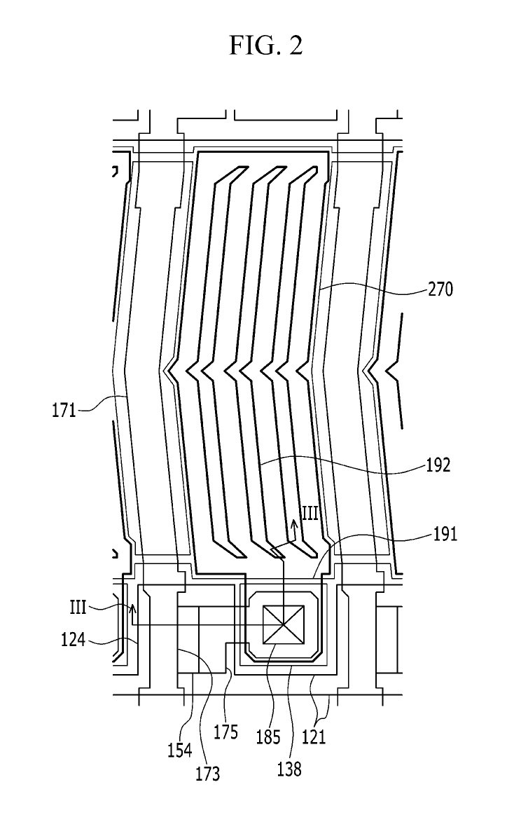

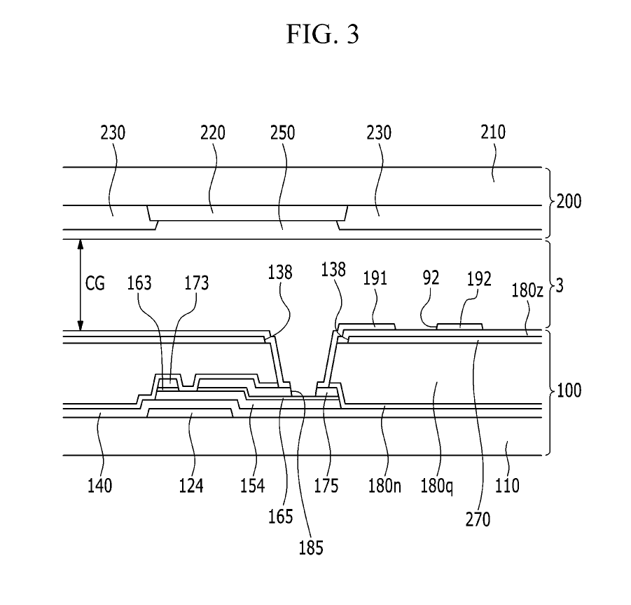

Hereinafter, an exemplary embodiment of the liquid crystal display according to the invention will be described with reference to FIG. 2 and FIG. 3. FIG. 2 is a plan view of an exemplary embodiment of a liquid crystal display according to the invention, and FIG. 3 is a cross-sectional view taken along line III-III of the liquid crystal display of FIG. 2.

Referring to FIG. 2 and FIG. 3, an exemplary embodiment of the liquid crystal display according to the invention includes the first display panel 100 and the second display panel 200 facing each other, and the liquid crystal layer 3 injected therebetween.

First, the first display panel 100 will be described in greater detail.

In an exemplary embodiment, the first display panel 100 includes the first substrate 110 including a transparent material, such as glass, plastics, or the like, for example, and a gate conductor including a gate line 121 is disposed on the first substrate 110.

In such an embodiment, the gate line 121 includes a gate electrode 124, and a wide end portion (not shown) for connection with another layer or an external driving circuit.

In such an embodiment, a gate insulating layer 140 including a silicon nitride (SiNx), a silicon oxide (SiOx), or the like is disposed on the gate conductor, e.g., the gate line 121 and the gate electrode 124. The gate insulating layer 140 may have a multilayered structure including at least two insulating layers having different physical properties from each other.

In such an embodiment, a semiconductor layer 154 including amorphous silicon, polysilicon, or the like is disposed on the gate insulating layer 140. In one exemplary embodiment, for example, the semiconductor layer 154 may include an oxide semiconductor.

In such an embodiment, ohmic contacts 163 and 165 are disposed on the semiconductor layer 154. The ohmic contacts 163 and 165 may include or be made of a material such as n+ hydrogenated amorphous silicon, in which an n-type impurity such as phosphorus is doped at a high concentration, or a silicide. The ohmic contacts 163 and 165 may be disposed as a pair on the semiconductor layer 154. In an exemplary embodiment, where the semiconductor 154 is the oxide semiconductor, the ohmic contacts 163 and 165 may be omitted.

In such an embodiment, a data conductor including a data line 171 including a source electrode 173 and a drain electrode 175 is disposed on the ohmic contacts 163 and 165, and the gate insulating layer 140.

In such an embodiment, the data line 171 includes a wide end portion (not shown) for connection with another layer or an external driving circuit. The data line 171 transmits a data signal and extends substantially in a vertical direction to cross the gate line 121.

In such an embodiment, the data line 171 may have a first curved portion having a curved shape to obtain maximum transmittance of the liquid crystal display, and curved portions meet each other at the center region of the pixel area, thereby forming a V-like shape. The center region of the pixel area may further include a second curved portion inclined from the first curved portion with a predetermined angle.

The first curved portion of the data line 171 may be bent to form an angle of about 7° with a vertical reference line forming an angle of 90° in an extension direction of the gate line 121. The second curved portion disposed in the middle region of the pixel region may be further bent to form an angle in a range of about 7° to about 15° with the first bent portion.

In such an embodiment, the source electrode 173 is defined by a portion of the data line 171, and is disposed on the same line as the data line 171. The drain electrode 175 is substantially parallel to the source electrode 173. Accordingly, the drain electrode 175 is substantially parallel to a portion of the data line 171.

In such an embodiment, the gate electrode 124, the source electrode 173 and the drain electrode 175 collectively define a thin film transistor (“TFT”) as a switching element along with the semiconductor 154, and a channel of the thin film transistor is formed in the semiconductor 154 between the source electrode 173 and the drain electrode 175.

An exemplary embodiment, the liquid crystal display according to the invention may include the source electrode 173 disposed on the same line as the data line 171 and the drain electrode 175 extending substantially parallel to the data line 171 to increase a width of the thin film transistor without increasing the area of the data conductor, thus increasing an opening ratio of the liquid crystal display.

In such an embodiment, a first passivation layer 180n is disposed on the data conductor 171, 173 and 175, the gate insulating layer 140, and the exposed portion of the semiconductor 154. The first passivation layer 180n may include or be made of an organic insulating material or an inorganic insulating material. In such an embodiment, a second passivation layer 180q is disposed on the first passivation layer 180n. The second passivation layer 180q may include an organic material.

In such an embodiment, a common electrode 270 is disposed on the second passivation layer 180q.

The common electrode 270 may be a flat type, e.g., have a plate-like shape, may be disposed to cover the whole surface of the first substrate 110 as an integrated plate, and an opening 138, which is located in an area corresponding to the circumference of the drain electrode 175, is defined in the common electrode 270. In an exemplary embodiment, the common electrode 270 may have a planar shape.

In such an embodiment, the common electrodes 270 disposed on adjacent pixels are connected to each other to receive a common voltage of a predetermined level supplied from outside of the display area.

In such an embodiment, a third passivation layer 180z is disposed on the common electrode 270. The third passivation layer 180z may be made of the organic insulating material or the inorganic insulating material.

In such an embodiment, a pixel electrode 191 is disposed on the third passivation layer 180z. The pixel electrode 191 may include a curved edge, which is substantially parallel to the first curved portion and the second curved portion of the data line 171. A plurality of cutouts 92 may be defined in the pixel electrode 191, and the pixel electrode 191 may include a plurality of branch electrodes 192 defined by the adjacent cutouts 92.

In such an embodiment, a first contact hole 185 that exposes the drain electrode 175 is defined through the first passivation layer 180n, the second passivation layer 180q and the third passivation layer 180z. The pixel electrode 191 is physically and electrically connected to the drain electrode 175 through the first contact hole 185 to receive a voltage from the drain electrode 175.

In such an embodiment, a first alignment layer (not shown) may be coated on the pixel electrode 191 and the third passivation layer 180z. In an exemplary embodiment, the first alignment layer may be a horizontal alignment layer and is rubbed in a predetermined direction. In an alternative exemplary embodiment of the liquid crystal display according to the invention, the first alignment layer may include a photoreactive material to be photo-aligned.

Now, the second display panel 200 will be described in greater detail.

In an exemplary embodiment, the second display panel 200 include the second substrate 210 including a transparent material, such as glass, plastic or the like, for example, and a light blocking member 220 disposed on the second substrate 210. The light blocking member 220 is also referred to as a black matrix and effectively prevents light leakage.

In such an embodiment, a plurality of color filters 230 is disposed on the second substrate 210. Each color filter 230 may uniquely display one of the primary colors, e.g., three primary colors such as red, green and blue, or yellow, cyan and magenta. In an exemplary embodiment, the color filter may further include a color filter for displaying a combination color of the primary colors, or white, other than the primary colors.

In such an embodiment, the overcoat 250 is disposed on the color filter 230 and the light blocking member 220. The overcoat 250 may include or be made of an (organic) insulator, and effectively prevents the color filters from being exposed to provide a flat surface. In an alternative exemplary embodiment, the overcoat 250 may be omitted.

In such an embodiment, a second alignment layer (not shown) is formed on the overcoat 250.

In an exemplary embodiment, the liquid crystal layer 3 includes a plurality of liquid crystal molecules having positive dielectric anisotropy or negative dielectric anisotropy. The liquid crystal molecules of the liquid crystal layer 3 are arranged such that the longitudinal axis thereof is aligned in a direction substantially parallel to a surface of the first and second display panels 100 and 200.

In such an embodiment, the pixel electrode 191 receives a data voltage from the drain electrode 175, and the common electrode 270 receives a common voltage having a predetermined voltage level from a common voltage applying unit disposed outside of the display region.

The liquid crystal molecules of the liquid crystal layer 3 disposed on the two field generating electrodes 191 and 270 are rotated in a direction that is substantially parallel to a direction of an electric field by the electric field generated by the pixel electrode 191 and the common electrode 270. As described above, polarization of light passing through the liquid crystal layer is changed according to the determined rotated direction of the liquid crystal molecules.

Referring to FIG. 1, an exemplary embodiment of the liquid crystal display includes the first pixel PXa, the second pixel PXb and the third pixel PXc, which display the different colors from each other.

The thickness of the second passivation layer 180q disposed in the first pixel PXa, the second pixel PXb and the third pixel PXc may be different from each other. The cell interval CG (the cell gap) defined as the interval between the first display panel 100 and the second display panel 200 may be differentiated depending on the thickness difference of the second passivation layer 180q.

As described above, the cell interval in the first pixel PXa, the second pixel PXb and the third pixel PXc may be different from each other due to the different thicknesses of the insulating layer 80 in the first pixel PXa, the second pixel PXb and the third pixel PXc. In such an embodiment, the value of the color coordinates may be controlled by controlling the cell intervals of the pixels displaying the different colors.

In one exemplary embodiment, for example, when the cell interval CG of the pixel displaying the red is increased, the long wavelength transmittance is increased and the value X among the tristimulus values of the color is increased, thereby increasing the value Wx. For example, if the cell interval of the pixel for displaying the red is increased by about 0.1 μm, the value Wx among the color coordinates is increased by about 2/1000.

In such an embodiment, when the cell interval CG of the pixel displaying the blue is decreased, the short wavelength transmittance is increased, and the values X and Z of the tristimulus values among the color are increased such that the value Wy is decreased. For example, if the cell interval of the pixel for displaying the blue is decreased by about 0.1 μm, the value Wy of the color coordinate is decreased by about 3/1000.

As described above, in an exemplary embodiment of the liquid crystal display according to the invention, the pixel electrode 191 and the common electrode 270 are disposed on the first substrate 110 and the thickness of the second passivation layer 180q as the organic layer disposed between the pixel electrode 191 and the common electrode 270 is differently set to control the cell intervals of the pixels that display different colors, thereby controlling the values of the color coordinates. Accordingly, in such an embodiment of the liquid crystal display, where the pixel electrode and the common electrode are disposed on a same substrate, the color coordinates of the liquid crystal display may be effectively controlled without substantial reduction of the transmittance of the liquid crystal display.

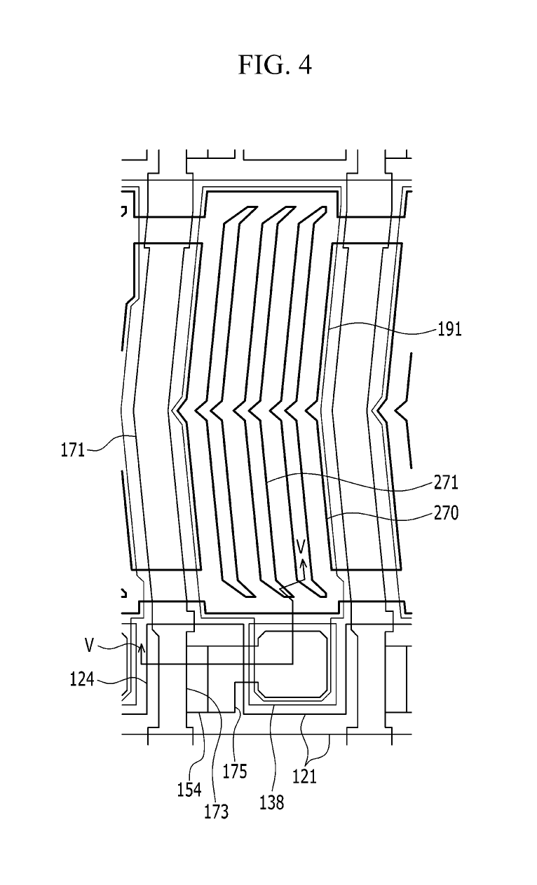

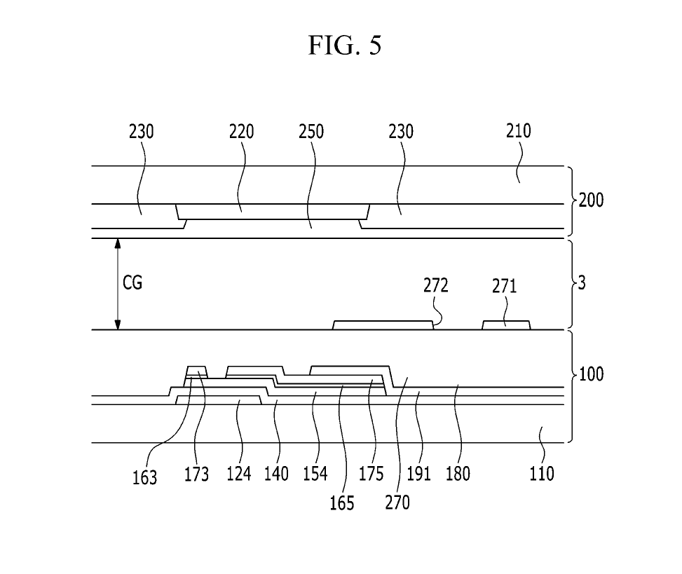

Next, an alternative exemplary embodiment of a liquid crystal display according to the invention will be described with reference to FIG. 4 and FIG. 5. FIG. 4 is a plan view of an alternative exemplary embodiment of a liquid crystal display according to the invention, and FIG. 5 is a cross-sectional view taken along line V-V of the liquid crystal display of FIG. 4.

The liquid crystal display shown in FIG. 4 and FIG. 5 is similar to the liquid crystal display shown in FIG. 2 and FIG. 3. The same or like elements shown in FIG. 4 and FIG. 5 have been labeled with the same reference characters as used above to describe exemplary embodiments of the liquid crystal display shown in FIG. 2 and FIG. 3, and any repetitive detailed description thereof will hereinafter be omitted or simplified

Referring to FIG. 4 and FIG. 5, an exemplary embodiment of the liquid crystal display includes a first display panel 100 and a second display panel 200, which are opposite to each other, and a liquid crystal layer 3 disposed between the first and second display panels 100 and 200.

First, the first display panel 100 will be described in detail.

In such an embodiment, the first display panel 100 includes the first substrate 110, and the gate conductor including a gate line 121 and disposed on the first substrate 110.

The first display panel 100 may further include a gate insulating layer 140 including a silicon nitride (SiNx), a silicon oxide (SiOx), or the like and disposed on the gate line 121.

The first display panel 100 may further include a semiconductor 154 disposed on the gate insulating layer 140.

The first display panel 100 may further include ohmic contacts 163 and 165 disposed on the semiconductor 154. In an exemplary embodiment, where the semiconductor 154 is the oxide semiconductor, the ohmic contacts 163 and 165 may be omitted.

In the first display panel 100, the data conductor including a data line 171 including a source electrode 173 and a drain electrode 175 is disposed on the ohmic contacts 163 and 165 and the gate insulating layer 140.

The first display panel 100 may further include a pixel electrode 191 disposed directly on the drain electrode 175. The pixel electrode 191 may be disposed in one pixel region to have a surface shape, that is, a plate shape.

The first display panel 100 may further include a passivation layer 180 disposed on the data conductors 171, 173 and 175, the gate insulating layer 140, the exposed portion of the semiconductor 154, and the pixel electrode 191. The passivation layer 180 includes an organic material. In an alternative exemplary embodiment of the liquid crystal display according to the invention, the first display panel 100 may further include a passivation layer (not shown) additionally disposed between the pixel electrode 191 and the data line 171, and the pixel electrode 191 may be connected to the drain electrode 175 through a contact hole (not shown) defined in the additional passivation layer.

The first display panel 100 may further include a common electrode 270 disposed on the passivation layer 180. The common electrodes 270 are connected to each other and receive a reference voltage from a common voltage application unit disposed outside the display area.

The common electrode 270 may include a curved edge which is substantially parallel to a first curved portion and a second curved portion of the data line 171, and the common electrodes 270 disposed at adjacent pixels may be connected to each other. A plurality of second cutouts 272 may be defined in the common electrode 270, and the common electrode 270 may include a plurality of second branch electrodes 271 defined by the plurality of second cutouts 272.

In an exemplary embodiment, a first alignment layer (not shown) may be coated on the common electrode 270 and the passivation layer 180, and the first alignment layer may be a horizontal alignment layer and may be rubbed in a predetermined direction. In an alternative exemplary embodiment of the liquid crystal display according to the invention, the first alignment layer may include a photoreactive material to be photo-aligned.

Now, the second display panel 200 will be described in greater detail.

The second display panel 200 includes the second substrate 210 and a light blocking member 220 disposed on the second substrate 210. The second display panel 200 may further include a plurality of color filters 230 disposed on the second substrate 210.

The second display panel 200 include an overcoat 250 disposed on the color filter 230 and the light blocking member 220. In an alternative exemplary embodiment, the overcoat 250 may be omitted.

In an exemplary embodiment, a second alignment layer (not shown) may be disposed on the overcoat 250.

In an exemplary embodiment, the liquid crystal layer 3 includes a plurality of liquid crystal molecules having positive dielectric anisotropy or negative dielectric anisotropy. The liquid crystal molecules of the liquid crystal layer 3 are arranged such that the longitudinal axis direction thereof is aligned substantially parallel to a surface of the first and second display panels 100 and 200.

The pixel electrode 191 receives a data voltage from the drain electrode 175, and the common electrode 270 receives a common voltage having a predetermined voltage level from a common voltage applying unit disposed outside of the display region.

The liquid crystal molecules of the liquid crystal layer 3 disposed on the two field generating electrodes 191 and 270 are rotated in a direction that is substantially parallel to a direction of an electric field by the electric field generated by the pixel electrode 191 and the common electrode 270. As described above, polarization of light passing through the liquid crystal layer is changed according to the determined rotated direction of the liquid crystal molecules.

Referring back to FIG. 1, in such an embodiment shown in FIGS. 5 and 6, the liquid crystal display includes the first pixel PXa, the second pixel PXb and the third pixel PXc, which display different colors from each other.

The thicknesses of the insulating layer 80 disposed in the first pixel PXa, the second pixel PXb, and the third pixel PXc may be different from each other. The cell interval CG (the cell gap) as the interval between the first display panel 100 and the second display panel 200 may be differently set based on the thickness difference of the insulating layer 80.

As described above, the cell interval may be differentiated in first pixel PXa, the second pixel PXb, and the third pixel PXc by differentiating the thicknesses of the insulating layer 80 in the first pixel PXa, the second pixel PXb and the third pixel PXc. In such an embodiment, the values of the color coordinates may be controlled by controlling the cell intervals of the pixels displaying the different colors.

In one exemplary embodiment, for example, when the cell interval CG of the pixel displaying the red is increased, the long wavelength transmittance is increased and the value X among the tristimulus value of the color is increased, thereby increasing the value Wx. For example, if the cell interval of the pixel for displaying the red is increased by about 0.1 μm, the value Wx among the color coordinates is increased by about 2/1000.

In such an embodiment, when the cell interval CG of the pixel for displaying the blue is decreased, the short wavelength transmittance is increased, and the values X and Z of the tristimulus values among the color are increased, such that the value Wy is decreased. For example, if the cell interval of the pixel for displaying the blue is decreased by about 0.1 μm, the value Wy of the color coordinates is decreased by about 3/1000.

As described above, according to an exemplary embodiment of the liquid crystal display of the invention, the pixel electrode 191 and the common electrode 270 are disposed on a same substrate, e.g., the first substrate 110, and the thickness of the insulating layer 80 as the organic layer disposed between the pixel electrode 191 and the common electrode 270 is differently set to allow the cell intervals of the pixels that display different colors to be different from each other, thereby effectively controlling the values of the color coordinates. Accordingly, in an exemplary embodiment of the liquid crystal display of the invention, where the pixel electrode and the common electrode are disposed on a same substrate, the color coordinates of the liquid crystal display may be effectively controlled without substantial reduction of the transmittance of the liquid crystal display.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate, on which a first pixel, a second pixel and a third pixel are defined, wherein the first pixel, the second pixel and the third pixel display different colors from each other;
a first electrode disposed on the first substrate;
a second electrode disposed on the first substrate;
an insulating layer disposed between the first electrode and the second electrode;
a second substrate disposed opposite to the first substrate; and
a liquid crystal layer disposed between the first substrate and the second substrate,
wherein a first thickness of the insulating layer in the first pixel is different from a second thickness of the insulating layer in the second pixel.

2. The liquid crystal display of claim 1, wherein
the second thickness of the insulating layer in the second pixel is different from a third thickness of the insulating layer in the third pixel.

3. The liquid crystal display of claim 2, wherein
a difference between the first thickness of the insulating layer and the second thickness of the insulating layer is larger than about zero (0) micrometer to less than about 0.5 micrometers, and
a difference between the second thickness of the insulating layer and the third thickness of the insulating layer is larger than about zero (0) micrometer to less than about 0.5 micrometers.

4. The liquid crystal display of claim 2, wherein
a first cell interval in the first pixel is different from a second cell interval in the second pixel.

5. The liquid crystal display of claim 4, wherein
the second cell interval in the second pixel is different from a third cell interval in the third pixel.

6. The liquid crystal display of claim 5, wherein
the difference between the first cell interval in the first pixel and the second cell interval in the second pixel is larger than about zero (0) micrometer to less than about 0.5 micrometers, and
the difference between the second cell interval in the second pixel and the third cell interval in the third pixel is larger than about zero (0) micrometer to less than about 0.5 micrometers.

7. The liquid crystal display of claim 5, wherein
a plurality of cutouts is defined in one of the first electrode and the second electrode, and
the one of the first electrode and the second electrode comprises a plurality of branch electrodes defined by the plurality of cutouts.

8. The liquid crystal display of claim 1, wherein
a cell interval in the first pixel is different from a cell interval in the second pixel.

9. The liquid crystal display of claim 8, wherein
the difference between the first cell interval in the first pixel and the second cell interval in the second pixel is larger than about zero (0) micrometer to less than about 0.5 micrometers.

10. The liquid crystal display of claim 8, wherein
a plurality of cutouts is defined in one of the first electrode and the second electrode, and
the one of the first electrode and the second electrode comprises a plurality of branch electrodes defined by the plurality of cutouts.

11. A liquid crystal display comprising:
a first substrate, on which a first pixel, a second pixel and a third pixel are defined, wherein the first pixel, the second pixel and the third pixel display different colors from each other;
a first electrode disposed on the first substrate;
a second electrode disposed on the first substrate;
an insulating layer disposed between the first electrode and the second electrode;
a second substrate disposed opposite to the first substrate; and
a liquid crystal layer disposed between the first substrate and the second substrate,
wherein a first cell interval in the first pixel is different from a second cell interval in the second pixel.

12. The liquid crystal display of claim 11, wherein
the second cell interval in the second pixel is different from a third cell interval in the third pixel.

13. The liquid crystal display of claim 12, wherein
the difference between the first cell interval in the first pixel and the second cell interval in the second pixel is larger than about zero (0) micrometer to less than about 0.5 micrometers, and
the difference between the second cell interval in the second pixel and the third cell interval in the third pixel is larger than about zero (0) micrometer to less than about 0.5 micrometers.

14. The liquid crystal display of claim 12, wherein
a plurality of cutouts is defined in one of the first electrode and the second electrode, and
the one of the first electrode and the second electrode comprises a plurality of branch electrodes defined by the plurality of cutouts.

15. The liquid crystal display of claim 11, wherein
a plurality of cutouts is defined by one of the first electrode and the second electrode, and
the one of the first electrode and the second electrode comprises a plurality of branch electrodes defined by the plurality of cutouts.
